(19) United States
(12) Patent Application Publication
(10) Pub. No.: US 2013/0048755 A1
(43) Pub. Date: Feb. 28, 2013

(54) FOAM DISPENSING PUMP CONTAINER

(71) Applicants: Shouji Uehira, Sagamihara-shi (JP); Akihito Onodera, Sagamihara-shi (JP); Kazuya Abe, Sagamihara-shi (JP)

(72) Inventors: Shouji Uehira, Sagamihara-shi (JP); Akihito Onodera, Sagamihara-shi (JP); Kazuya Abe, Sagamihara-shi (JP)

(73) Assignee: DAIWA CAN COMPANY, Tokyo (JP)

(21) Appl. No.: 13/522,631

(22) PCT Filed: Jan. 13, 2011
(86) PCT No.: PCT/JP11/50388

§ 371 Date: Oct. 15, 2012

(30) Foreign Application Priority Data
Jan. 22, 2010 (JP) 2010-012461

(51) Int. Cl. B05B 7/30; B65D 83/76

(52) U.S. Cl. 239/318; 222/382

(57) ABSTRACT

A foam dispensing pump container having a suction inlet capable of introducing a large amount of external air while preventing ingress of water and foam certainly.

In the foam dispensing pump container, a suction inlet 45 is opened to an opposite side of a discharging outlet 43 of the nozzle member 4. The suction inlet 45 is communicated with an air course formed between an inner cylinder 41 and an outer cylinder 42 through a through hole 46. A skirt shaped cover portion 47 is formed to extend downwardly from an outer circumferential edge of the ceiling of the nozzle member 4 to a level lower than the suction inlet 45. In order to divide and shut off an inner space of the skirt shaped cover portion 47 (i.e., a space between an inner face of the cover portion 47 and the outer cylinder 42), at least one pair of partitions 49 are formed on both sides of the suction inlet 45 in the circumferential direction of the nozzle member 4.

### TECHNICAL FIELD

This invention relates to a foam dispensing pump container, which is configured to produce foam of liquid contained in a container by repeatedly pushing and releasing a nozzle member as a pushing head arranged above a cap of the container, and configured to discharge the foam from a discharging outlet of the nozzle member. More specifically, the present invention relates to a foam dispensing pump container in which a suction inlet for introducing external air is formed in the nozzle member.

### BACKGROUND ART

Shampoo, hand soap, body soap, facial cleaning foam, hair styling mousse, shaving foam, bathtub cleanser and so on are foamed when used. Therefore, various kinds of foam dispensing containers of the above mentioned liquids have been commercialized in the market. Such containers are called as a “foam dispensing pump container”, and the foam dispensing pump container is provided with a pumping mechanism composed mainly of a nozzle member, a cylinder member, and a piston member. In the foam dispensing pump container, the piston member is arranged to protrude through a top panel of the cap while being pushed upwardly by a spring, and connected with the nozzle member situated above the cap of the container. Therefore, the piston member is moved downwardly within a predetermined range against a spring force by pushing down the nozzle member, and pushed upwardly by the spring force by releasing the nozzle member. In the container, the cylinder member hangs down on the opening of the container, and the piston member is inserted into the cylinder member. Therefore, the liquid contained in the container is sucked up from a lower end of the cylinder member by reciprocating the piston member. The liquid thus sucked up is then mixed with air to be foamed, and discharged out of the container from the discharging outlet of the nozzle member via the piston member and a hollow axis of the nozzle member.

After thus discharging the foam by operating the pumping mechanism, an internal pressure of the foam dispensing pump container becomes negative pressure. Therefore, in order to fill up the container with the air and to produce the foam, it is necessary to introduce external air into the container. For this purpose, the conventional pump containers are configured to suck the external air from a clearance created at a portion where the nozzle member is overlapped slidably onto a guide stem of the cap. However, according to the conventional pump container thus structured, water adhering onto an outer circumferential face of the guide stem may be sucked easily into the container or the (air) cylinder together with the air. In addition, the air cannot be sucked into the container sufficiently and promptly from such a narrow clearance. Therefore, in case of discharging large amount the foam promptly, the external air may be delayed to be introduced into the container.

For example, Japanese Patent Laid-Open No. 2007-275777 discloses a foam discharge vessel having an opening for introducing external air. In the vessel taught by Japanese Patent Laid-Open No. 2007-275777, a clearance also exists between a guide stem of a cap (i.e., a base cap) and a nozzle member (i.e., a foam dispensing device). In addition, a suction inlet (i.e., an outside air intake port) having a large opening surface area is formed on an outer cylinder (i.e., a skirt-like cover) of the nozzle member (i.e., the foam dispensing device). Further, a protection wall 33 is formed above and in the vicinity of the suction inlet (i.e., the outside air intake port) on an outer circumferential side of the suction inlet.

Thus, in the conventional pump container, the suction inlet (i.e., the outside air intake port) having a large opening surface area is formed on the outer cylinder (i.e., the skirt-like cover) of the nozzle member (i.e., the foam dispensing device). Therefore, the conventional pump container thus structured is capable of preventing water from being sucked with the external air from the clearance between the guide stem and the nozzle member (i.e., the foam dispensing device). In addition, an intrusion of scattering water into the suction inlet (i.e., the outside air intake port) from above or from the side can be prevented by the protection wall thus formed above and in the vicinity of the suction inlet (i.e., the outside air intake port) on an outer circumferential side of the suction inlet.

However, as described, the suction inlet (i.e., the outside air intake port) is formed on the outer cylinder (i.e., the skirt-like cover) of the nozzle member (i.e., the foam dispensing device) in the vessel taught by Japanese Patent Laid-Open No. 2007-275777. Therefore, for example, in case the vessel falls sideways or in case the vessel is inclined obliquely downwardly, water adhering to the outer circumferential face of the outer cylinder (i.e., the skirt-like cover) is flown toward the suction inlet (i.e., the outside air intake port) without being hindered by the protection wall. The water thus flowing on the outer circumferential face may intrude into the vessel from the suction inlet (i.e., the outside air intake port).

If the external water thus enters into the container, lubricant such as silicon applied to the cylinder member is washed away by the intruding water. In this case, therefore, smoothness of reciprocating movement of the piston member may be degraded. Moreover, the intruding water comes to be mixed with the liquid (i.e., detergent) contained in the container thereby changing color and flavor of the liquid. In addition, if a large amount of water remains in a space defined by the cylinder member and the piston member, a ratio between the liquid and air to be supplied to the mixing chamber is changed from that at the beginning of use. Consequently, quality of the foam may be degraded from an expected quality of the foam. Further, the water thus intruding into the container is most likely contaminated, and such contaminated water remains in the air cylinder to encourage mold growth therein. If the air cylinder is molded, mold odor is transmitted to the mixing chamber by a pumping operation thereby deteriorating the flavor of the discharged foam.

### DISCLOSURE OF THE INVENTION

As described, various improvement has been achieved to prevent the ingress of water into the container from the air suction inlet. However, the foam dispensing pump containers are used in various situations. Therefore, a total solution for the ingress of water into the container has not yet established in the prior art. For example, in case a large amount of the foam is discharged from the container, the foam is heaped on a hand, sponge, towel and so on. If the hand, sponge, etc. on which the foam is thus heaped is contacted with the outer cylinder of the nozzle member being reciprocated repeatedly to discharge the foam, the foam may be sucked into the air chamber of the pumping mechanism.

In this situation, specifically, the foam heaped on the hand etc. flows in the circumferential direction of the nozzle member toward the suction inlet via the outer circumferential face of the outer cylinder of the nozzle member, and an inner space of a skirt shaped cover (i.e., an inner space between the cover and the outer cylinder). Therefore, the foam thus reaches the suction inlet is sucked into the suction inlet together with the external air when the nozzle member is returned upwardly.

The present invention has been conceived to solve the above-explained disadvantages of the foam dispensing pump container. Therefore, an objective of the present invention is to form a suction inlet capable of introducing a large amount of external air while preventing the ingress of water thereto, and to certainly prevent the ingress of foam into the suction inlet of the foam dispensing pump container.

In order to achieve the above-mentioned object, according to the present invention, there is provided a foam dispensing pump container, comprising: a cylinder member extending from an opening of a container toward an inner space of the container; a piston member, which is arranged in the cylinder member in a manner to reciprocate vertically within a predetermined range, and which is constantly pushed upwardly; a cap, which is fitted onto the opening of the container to cover the piston member from above; a cylindrical guide stem, which is erected around an opening edge of a top panel of the cap; a nozzle member, which is arranged outside of the container, and which has a discharging outlet, an inner cylinder connected with the piston member to form a discharging passage, and an outer cylinder configured to reciprocate vertically on an outer circumferential face of the guide stem; and an air course, which is formed between the inner cylinder and the outer cylinder to introduce external air into the container. The foam dispensing pump container thus structured is characterized by: a space, which is formed in a ceiling of the nozzle member and closed by a lid; a recessed portion, which is formed outside of an outer circumferential face of the outer cylinder in said space; a suction inlet, which is formed on an outer wall of the recessed portion and situated on an opposite side of the discharging outlet of the nozzle member to introduce the external air. A portion of said space inside of the recessed portion is communicated with the air course formed between the inner cylinder and the outer cylinder. In addition, the foam dispensing pump container is further characterized by: a skirt shaped cover portion, which is formed in the outer circumferential side of the recessed portion, and which extends downwardly from an outer circumferential edge of the ceiling of the nozzle member to a level lower than the suction inlet; and a partition, which is arranged on both sides of the suction inlet in a circumferential direction of the nozzle member to divide and close an inner space of the skirt shaped cover portion.

According to the present invention, therefore, the foam dispensing pump container is capable of introducing a large amount of external air into the container from the suction inlet formed in the nozzle member so that the foam of the content can be discharged promptly in a large amount. In addition, in case the foam dispensing pump container stands upright, the ingress of water into the suction inlet can be prevented by the skirt shaped cover portion. As described, the suction inlet is formed on the outer wall of the recessed portion situated outside of the outer circumferential face of the outer cylinder. Therefore, even in case the foam dispensing pump container falls sideways, or in case the foam dispensing pump container is inclined obliquely downwardly, the water flowing on the outer circumferential face of the outer cylinder toward the suction inlet is blocked by the bottom wall of the recessed portion functioning as a waterproof barrier. Thus according to the present invention, an intrusion of water into the container from the suction inlet can be prevented effectively.

In case of discharging the foam onto a hand (or a sponge on the hand) placed underneath the discharging outlet by pushing the nozzle member several times, the discharged foam is heaped on the hand (or on the sponge). In this situation, if the hand (or the sponge) is contacted with the outer cylinder of the nozzle member, a portion of the foam on the hand (or the sponge) may flow into the inner space of the skirt shaped cover portion via the outer circumferential face of the outer cylinder. According to the foam dispensing pump container of the present invention, however, the inner space of the skirt shaped cover portion is divided by the partitions. Therefore, the foam thus flowing through the inner space of the cover portion in the circumferential direction toward the suction inlet is blocked by the partitions to be prevented from approaching to the suction inlet. For this reason, the foam can be prevented effectively from being aspirated into the container (or the air chamber) together with the external air from the suction inlet.

### BRIEF DESCRIPTION OF THE DRAWINGS

FIG. 1 is a longitudinal sectional view showing one example of an entire structure of the foam dispensing pump container according to the present invention under the situation in which the nozzle member is situated at the upper limit position (In this figure, transverse lines connecting end portions of the cylindrical portion are not shown entirely but omitted partially).

FIG. 2 is a longitudinal sectional view showing the entire structure of the foam dispensing pump container shown in FIG. 1 under the situation in which the nozzle member is situated at the lower limit position (As in FIG. 1, transverse lines connecting end portions of the cylindrical portion are partially omitted).

FIG. 3 is a side view showing the nozzle member of the foam dispensing pump container shown in FIG. 1.

FIG. 4 is a top view showing the nozzle member shown in FIG. 3.

FIG. 5 is a top view showing the nozzle member shown in FIG. 3 in which the lid is dismounted from the ceiling.

FIG. 6 is a bottom view showing the nozzle member shown in FIG. 3.

FIG. 7 (A) is a sectional view showing a cross-section of the nozzle member shown in FIG. 3 along A-A line shown in FIG. 4, and FIG. 7 (B) is a sectional view showing a cross-section of the nozzle member shown in FIG. 3 along B-B line shown in FIG. 4

FIG. 8 (A) is a sectional view showing a cross-section of the nozzle member of another example along A-A line shown in FIG. 4, and FIG. 8 (B) is a sectional view showing a cross-section of the nozzle member of another example along B-B line shown in FIG. 4.

### BEST MODE FOR CARRYING OUT THE INVENTION

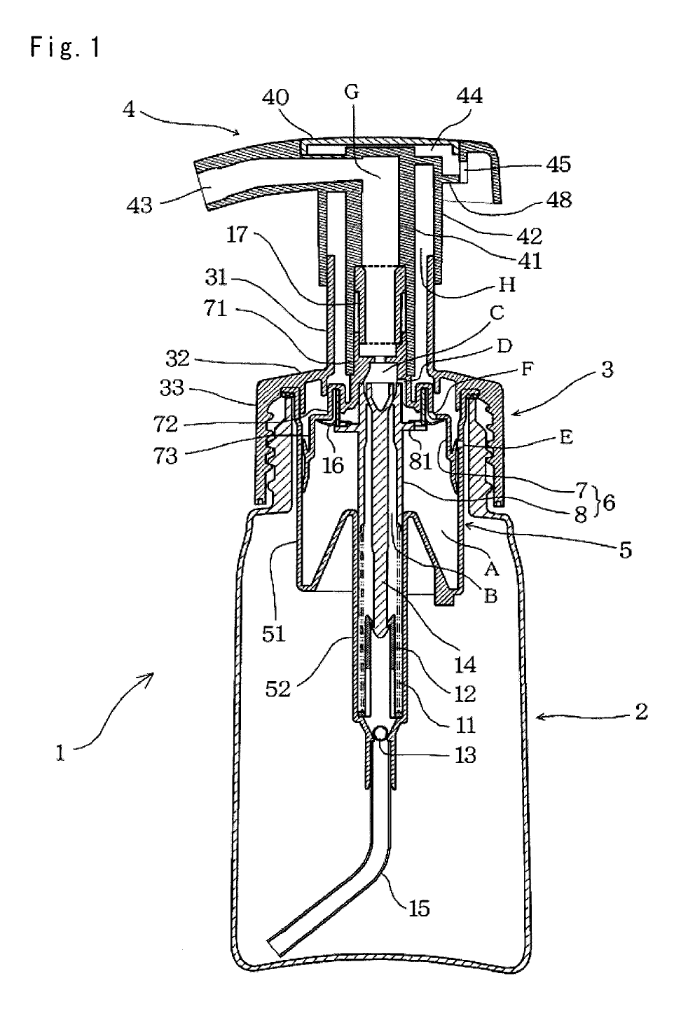

According to the present invention, the foam dispensing pump container 1 is configured to contain a liquid containing surfactant, for example, shampoo, hand soap, body soap, facial cleaning foam, hair styling mousse, shaving foam, bathtub cleanser and so on. As shown in FIG. 1, the container 1 comprises a pumping structure formed by a nozzle member 4, a cylinder member 5 and a piston member 6. Specifically, the nozzle member 4 is arranged outside of a container body 2 to be situated above a cap 3, and the cylinder member 5 is arranged inside of the container body 2 in a manner to extend inwardly from an opening of the container body 2 along a center axis of the container body 2. The piston member 6 comprises an air piston 7 and a liquid piston 8, and the piston member 6 is inserted into the cylinder member 5 fixed underneath the cap 3 while being allowed to reciprocate vertically.

The cap 3 is screwed onto the opening of the container body 2 to close the opening of the container 2. A central portion of a top panel 32 of the cap 3 is opened, and a cylindrical guide stem 31 is erected around the opening edge of the top panel 32. Meanwhile, an inner cylinder 41 and an outer cylinder 42 are formed integrally with the nozzle member 4. Specifically, the inner cylinder 41 is connected with an upper end of the piston member 6 to serve as a discharging passage inside of the guide stem 31 of the cap 3, and the outer cylinder 42 is configured to be reciprocated vertically on an outer circumferential face of the guide stem 31 of the cap 3. Therefore, the nozzle member 4 is reciprocated together with the piston member 6 connected therewith while being guided by the guide stem 31 of the cap 3. Here, the inner cylinder 41 and the outer cylinder 42 are not necessarily formed integrally with the nozzle member 4. That is, the inner cylinder 41 and the outer cylinder 42 may also be formed separately to be attached to the nozzle member 4.

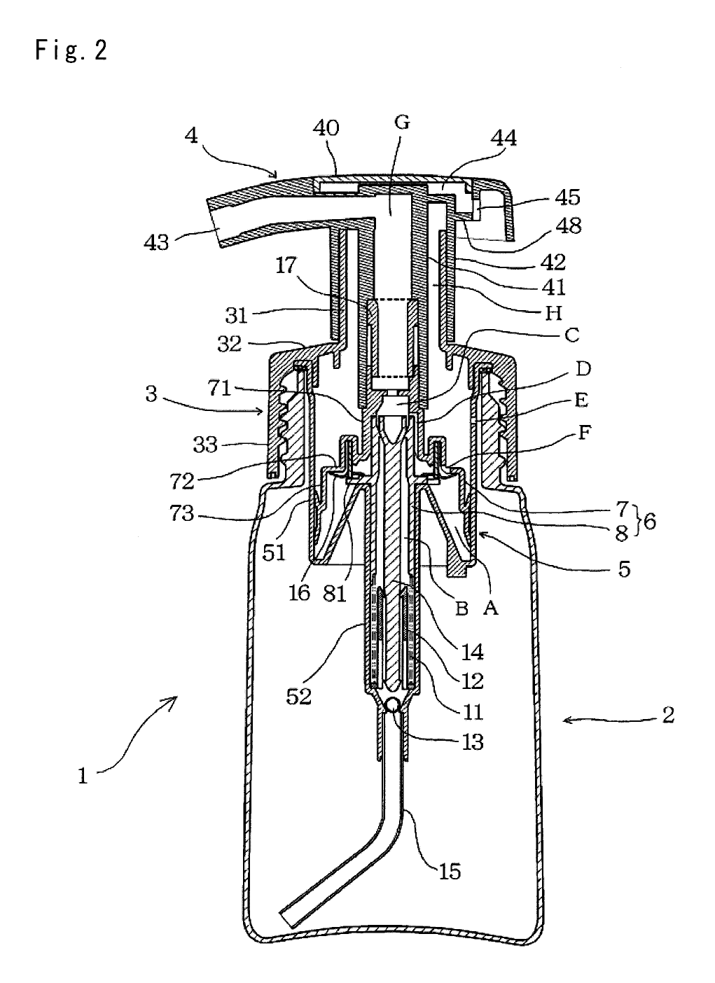

A coil spring 11 is arranged between the cylinder member 5 and the piston member 6. Therefore, the nozzle member 4 and the piston member 6 are always pushed upwardly by a spring force of the coil spring 11 in the cylinder member 5. In FIG. 1, the nozzle member 4 is situated at an upper limit position. However, the nozzle member 4 is allowed to be pushed down to a lower limit position shown in FIG. 2 by pushing the nozzle member 4 downwardly together with the piston member 6 against the spring force of the coil spring 11.

The above-mentioned pumping structure of the foam dispensing pump container 1 will be explained in more detail. As described, the cap 3 is screwed onto the opening of the container 2 in a detachable manner. Specifically, the cap 3 comprises: the top panel 32 having the opening at its center; the cylindrical guide stem 31 erected integrally from a circumferential edge of the opening of the top panel 32; and a cylindrical skirt 33 extending toward the container 2 integrally from an outer circumferential edge of the top panel 32. Specifically, an inner face of the cylindrical skirt 33 is threaded to be screwed onto the opening of the container body 2. In addition, a cylindrical holding portion for holding the cylinder member 5, and a cylindrical contact portion contacted with the piston member 6 are formed on a lower face of the top panel 32 concentrically.

The cylinder member 5 is a dual cylinder formed by an injection forming method using synthetic resin, comprising a diametrically larger air cylinder 51, a diametrically smaller liquid cylinder 52, and a conical connection connecting the air cylinder 3 and the liquid cylinder 52 concentrically and integrally. A flange portion is formed on an upper end portion of the air cylinder 51 to be interposed between the lower face of the top panel 32 and the opening of the container 2. Therefore, the cylinder member 5 is fixed concentrically with the cap 3 at its upper end portion in a manner to protrude downwardly into the container 2 by screwing the cap 3 onto the opening of the container 2.

In order to introduce air into a head space of the container 2 (i.e., into a space above a liquid surface in the container 2), an air hole E is formed on the upper portion of the air cylinder 51 of the cylinder member 5. In addition, a funnel-shaped valve seat is formed at a lower end of the liquid cylinder 52, and a suction tube 15 is inserted into the liquid cylinder 52 below the valve seat so as to introduce the liquid in the container 2 into the liquid cylinder 52. Specifically, the suction tube 15 extends to the extent of situating a lower end portion thereof in a vicinity of a bottom of the container 2.

As described, the piston member 6 is inserted into the cylinder member 5 in a manner to reciprocate vertically, and the piston member 6 comprises an air piston 7 and a liquid piston 8. The air piston 7 and the liquid piston 8 are formed separately by an injection forming method using synthetic resin, and those air piston 7 and liquid piston 8 are integrated in a concentrical manner to form the piston member 6. Specifically, the air piston 7 is arranged in the air cylinder 51 in a manner to slide on an inner face of the air cylinder 51, and the liquid piston 8 is arranged in the liquid cylinder 52 in a manner to slide on an inner face of the liquid cylinder 52. In addition, an upper end of the piston member 6 (i.e., an upper portion of a stem 71 of the air piston 7) is connected with a lower end of the inner cylinder 41.

The air piston 7 of the piston member 6 comprises: the diametrically smaller cylindrical stem 71 formed on the upper portion of the piston 7; a diametrically larger piston portion 73 formed below the stem 71; and an intermediate connection 72 connecting the stem 71 and the piston portion 73 integrally. In addition, a slidable sealing portion having a predetermined width is formed on the lower end of the piston portion 73, in a manner to ensure sufficient air-tightness between the inner face of the air cylinder 51 and the piston portion 73, while being allowed to be reciprocated vertically on the inner face of the air cylinder 51 by a small pushing force.

Specifically, the slidable sealing portion of the piston portion 73 of the air piston 7 has a predetermined width as described, and contacted tightly with the inner face of the air cylinder 51 at its both upper and lower ends. Therefore, in case the air piston 7 is situated at the upper limit position as illustrated in FIG. 1, the slidable sealing portion of the piston portion 73 closes the air hole E. To the contrary, in case the air piston 7 is pushed downwardly from the upper limit position, the slidable sealing portion of the piston portion 73 is moved downwardly to open the air hole E as illustrated in FIG. 2.

An upper portion of the stem 71 of the air piston 7 serves as a connection inserted into the lower portion of the inner cylinder 41 of the nozzle member 4, and a lower portion of the stem 71 serves as a connection fitted onto an upper portion of the liquid piston 8. Specifically, the upper portion of the stem 71 is diametrically shrunk in comparison with the lower portion thereby forming a step portion. Therefore, the lower end portion of the inner cylinder 41 of the nozzle member 4 is stopped at the step portion when fitted onto the stem 71, and the upper end portion of the liquid piston 8 is stopped at the step portion when inserted into the stem 71.

The liquid piston 8 of the piston member 6 is formed into a cylindrical shape entirely, and a valve seat is formed at the upper end portion thereof. Specifically, the valve seat is formed into an inverse conical shape (i.e., a funnel-shape) in which an inner diameter increases toward an upper end thereof. In addition, an annular projection 81 having radial protrusions on its outer circumferential edge is formed around an outer face of an intermediate portion of the liquid piston 8. An inner face of a lower end of the liquid piston 8 is contacted with an upper end portion of the coil spring 11 interposed between the liquid cylinder 52 and (a lower end of) a cylindrical retaining member 12 arranged in the liquid cylinder 52. Therefore, the piston member 6 is always pushed upwardly in the cylinder member 5 by the spring force of the coil spring 11, and as shown in FIG. 2, the piston member 6 in the cylinder member 5 is stopped by the annular projection 81 when pushed down.

The cylinder member 5 is covered by the piston member 6 thus structured. Consequently, an air chamber A is formed between an inner face of the air cylinder 51 and an outer face of the liquid piston 8, and a liquid chamber B is formed inside of the liquid piston 8 and the liquid cylinder 52. In addition, a mixing chamber C is formed above the liquid chamber B in an upper side of the stem 71 of the air piston 7. As described, the air hole E is formed on the upper portion of the air cylinder 51 to introduce air into the container body 2, and in order to introduce air into the air chamber A, a suction hole F is formed on the intermediate connection 72 of the air piston 7.

A plurality of grooves (preferably 3 to 7 grooves) are formed on the stem 71 to which the liquid piston 8 is inserted. Specifically, those grooves are formed on an inner face of a lower portion of the stem 71 longitudinally at regular intervals in a circumferential direction, and those grooves serve as air passages D to supply air from the air chamber A to the mixing chamber C. Alternatively, in order to form the air passage D between the inner face of the stem 71 and the outer face of the liquid piston 8, the longitudinal grooves (or ribs) may also be formed on the outer face of the liquid piston 8 instead of the inner face of the stem 71.

Thus, the air chamber A, the liquid chamber B, the mixing chamber C and the air passage D are formed by the cylinder member 5 and the piston member 6. In addition, the air hole E is formed on the cylinder member 5 (i.e., on the upper portion of the air cylinder 51), and the suction hole F is formed on the intermediate connection 72 of the air piston 7 of the piston member 6. Meanwhile, the valve seat formed at the lower side of the liquid cylinder 52 is closed by a ball valve 13 to form a first check valve. Therefore, an inlet of the liquid chamber B is opened in case a pressure in the liquid chamber B is negative.

A rod valve 14 having an inverse conical valve element on its upper end is inserted into the liquid cylinder 52 through the liquid piston 8. The above-mentioned cylindrical retaining member 12 is configured to allow the liquid to flow therethrough, and as described, the cylindrical retaining member 12 is arranged in the lower side of the liquid cylinder 52 above the valve seat. An upper end of the cylindrical retaining member 12 is engaged with a lower end of the rod valve 14. That is, the level at which the rod valve 14 is thus engaged with the cylindrical retaining member 12 is an upper limit position of the rod valve 14, and the rod valve 14 is allowed to reciprocate in the cylindrical retaining member 12 within a predetermined range below the upper limit position. Thus, a second check valve is formed by the valve seat formed on the upper end of the liquid piston 8 and the valve element formed on the upper end of the rod valve 14, and an outlet of the upper end of the liquid chamber B is opened in case the pressure in the liquid chamber B is raised.

Specifically, as shown in FIGS. 1 and 2, a diameter of the rod valve 14 is reduced at its lower portion to form a diametrically small rod portion, and the diameter of the valve 14 is enlarged sharply at a lower portion of the diametrically small rod portion to form a stopper portion (i.e., a step portion). On the other hand, an annular projection is formed on the upper end portion of the cylindrical retaining member 12 to protrude inwardly to reduce the inner diameter of the cylindrical retaining member 12 to be smaller than the diameter of the stopper portion. Therefore, in case the rod valve 14 thus inserted into the cylindrical retaining member 12 is returned upwardly, the rod valve 14 is stopped at the stopper portion formed on its lower portion (i.e., on the lower portion of the diametrically small rod portion) by the annular projection of the cylindrical retaining member 12. That is, the lower end portion of the rod valve 14 is held in the cylindrical retaining member 12 while being allowed to move vertically within a predetermined range below the annular protrusion. On the occasion of combining the cylinder member 5 with the piston member 6, the lower portion of the rod valve 14 (i.e., the lower portion of the diametrically small rod portion) has to be inserted into the cylindrical retaining member 12. On this occasion, specifically, the rod valve 14 is pushed into the cylindrical retaining member 12 from above while widening the annular projection formed on the upper end of the cylindrical retaining member 12 elastically by the stopper portion formed on the lower end of the rod valve 14.

In addition, a third check valve is formed in the example shown in the accompanying figures. Specifically, the third check valve is configured to introduce air into the air chamber A from the suction hole F under the situation in which the piston member 6 is pushed upwardly and the pressure in the air chamber A is therefore negative, and to allow the air in the air chamber A to be supplied to the mixing chamber C through the air passage D under the situation in which the piston member 6 is pushed downwardly and the pressure in the air chamber A is thereby raised. That is, the third check valve is configured to open and close the suction hole F and the air passage D. For this purpose, the third check valve is formed by: a portion of a lower face of the intermediate connection 72 of the air piston 7 at an outer circumferential side from the suction hole F; an upper face of the annular protrusion 81 protruding radially outwardly from the outer face of the intermediate portion of the liquid piston 8; and an elastic valve element 16 formed of soft synthetic resin.

Specifically, the elastic valve element 16 comprises a short cylindrical base portion; a thin annular outward valve portion formed integrally with the base portion to protrude outwardly from a lower end of the base portion; and a thin annular inward valve portion formed integrally with the base portion to protrude inwardly from the lower end of the base portion. The elastic valve element 16 thus structured is arranged between the intermediate connection 72 of the air piston 7 and the annular protrusion 81 of the liquid piston 8 concentrically therewith. In addition, an upper portion of the cylindrical base portion of the elastic valve element 16 is held in the intermediate connection 72 of the air piston 7, and a lower end portion of the cylindrical base portion of the elastic valve element 16 is sustained by a plurality of projections protruding from an outer circumferential edge of the annular protrusion 81 of the liquid piston 8. The elastic valve element 16 is thus positioned at an upper end of the air chamber A.

Specifically, in the third check valve thus structured, the outward valve portion of the elastic valve element 16 is contacted with the lower face of the intermediate connection 72 and the inward valve portion of the elastic valve element 16 is contacted with the upper face of the annular protrusion 81, under the situation in which the pressure in the air chamber A is at atmospheric pressure. In this situation, therefore, both of the inlets of the air passage D and the suction hole F are closed. To the contrary, in case the piston member 6 is pushed down and the air chamber A is thereby pressurized, the inward valve portion of the elastic valve element 16 is pushed upwardly (that is, deformed elastically) to be detached from the annular protrusion 81. In this case, therefore, the inlet of the air passage D is opened. Then, when the piston member 6 is returned upwardly and the pressure in the air chamber A becomes negative, the outward valve portion of the elastic valve element 16 is moved downwardly (that is, deformed elastically) to be detached from the intermediate connection 72. In this situation, therefore, the suction hole F is opened.

The nozzle member 4 serves as a pushing head of the foam dispensing pump container 1. Specifically, the nozzle member 4 comprises: an inner cylinder 41, which extends upwardly from the vicinity of the outlet (i.e., a downstream side) of the mixing chamber C; an outer cylinder 42, which is diametrically larger than the inner cylinder 41, and which is arranged concentrically with the inner cylinder 41 while keeping predetermined clearance; and a head portion, which is formed integrally with the inner cylinder 41 and the outer cylinder 42, and which has a discharging outlet 43. In the nozzle member 4 thus formed, therefore, an inverse L-shaped foam passage G is formed from the outlet of the mixing chamber C to the discharging outlet 43.

The upper portion of the stem 71 of the air cylinder 7 is inserted into the inner cylinder 41 of the nozzle member 4 from a lower end of the inner cylinder 41 to be connected integrally therewith. The portion at which the stem 71 is thus connected with the inner cylinder 41 penetrates through the opening of the cap 3 formed at the center of the top panel 32. Thus, the nozzle member 4 situated outside of the container body 2 and the piston member 6 situated inside of the container body 2 are connected integrally with each other while penetrating through the cap 3.

In addition, a porous holder 17 is inserted into the foam passage G in the downstream side of the mixing chamber C, and a porous sheet is arranged at each end of the porous holder 17. Specifically, the porous holder 17 is configured to homogenize the foam produced in the mixing chamber C by letting the foam therethrough. For example, the porous holder 17 can be prepared using a porous sheet such as a net formed from synthetic resin strings and a spacer also made of synthetic resin, and the synthetic resin net is adhered to the each end of the synthetic resin spacer. In addition, the porous sheet of downstream side (i.e., closer to the discharging outlet 43) is finer than the porous sheet of upstream side (i.e., closer to the mixing chamber C).

Here will be briefly explained an action of the foam dispensing pump container. As shown in FIG. 1, the nozzle member 4 and the piston member 6 of the pump container 1 thus structured are situated initially at the upper limit position before the user starts using the pump container 1. In this situation, the air hole E for introducing air into the container is closed by the slidable sealing portion of the air piston 7. In addition, the first check valve is closed by the ball valve 13, the second check valve is closed by the rod valve 14, and the third check valve is closed by the elastic valve element 16.

FIG. 2 shows a situation in which the nozzle member 4 is pushed down together with the piston member 6 to the lower limit position. In this situation, the first check valve is kept closed by the ball valve 13 to close the lower inlet of the liquid chamber B, but the rod valve 14 opens the second check valve to open the upper outlet of the liquid chamber B. In case the piston 6 is thus pushed down, the air chamber A is pressurized. In this case, therefore, the suction hole F is kept closed by the elastic valve element 16 of the third check valve, and the inlet of the air passage D is opened.

When the nozzle member 4 is pushed first time by the user, air is supplied from the air chamber A to the mixing chamber C. In this situation, only air in the liquid chamber B is also supplied to the mixing chamber C. Therefore, only air is discharged from the foam passage G of the nozzle member 4.

Then, when the nozzle member 4 thus being pushed down first time is released, the nozzle member 4 and the piston member 6 are pushed upwardly toward the upper limit position shown in FIG. 1 by the spring force of the coil spring 11. While the nozzle member 4 and the piston member 6 are thus being moved upwardly, the second check valve is closed by the rod valve 14 thereby closing the outlet of upper end of the liquid chamber B, and the pressure in the liquid chamber B is turned to be negative by such an uprising motion of the piston member 6. As a result, the first check valve is opened by the ball valve 13 thereby opening the inlet of lower end of the liquid chamber B. In addition, since the pressure in the air chamber A becomes negative, the elastic valve element 16 of the third check valve opens the suction hole F and closes the inlet of the air passage D.

As a result, the liquid in the container body 2 is sucked into the liquid chamber B through the suction tube 15, and external air is aspirated into the after-mentioned suction inlet 45. The air aspirated into the suction inlet 45 is supplied to the air chamber A through an air course H between the inner cylinder 41 and the outer cylinder 42, and through the suction hole F. As a result, a preparation to produce the form is completed.

After the liquid in the container body 2 is thus sucked into the liquid chamber B, a volume of the headspace in the container body 2 is increased in a reduction amount of the liquid. Consequently, the pressure in the headspace of the container body 2 may become negative in this situation, however, the air hole E is opened during the situation in which the nozzle member 4 and the piston member 6 are returned from the position shown in FIG. 2 to the position shown in FIG. 1. Therefore, the air flowing through the air course H between the inner cylinder 41 and the outer cylinder 42 is sucked into the container body 2 from the air hole E, so that the pressure in the headspace of the container body 2 is returned immediately to the atmospheric pressure.

When the piston member 4 is pushed down again after returned to the position shown in FIG. 1 and the liquid chamber B is filled with the liquid, the piston member 6 and the (first to third) check valves are activated as in the case of pushing down the piston member 4 first time. In this situation, the air chamber A and the liquid chamber B are pressurized by the downward motion of the piston member 6. As a result, the air in the air chamber A is pumped into the mixing chamber C through the air passage D, and the liquid in the liquid chamber B is also supplied to the mixing chamber C. The air and the liquid thus introduced into the mixing chamber C are mixed with each other to produce foam, and the foam thus produced passes through the porous sheets arranged at both ends of the porous holder 17 to be homogenized. Then, the foam thus homogenized is discharged from the discharging outlet 43 of the nozzle member 4 via the foam passage G.

Then, when the nozzle member 4 thus pushed down to the lower limit position shown in FIG. 2 is released, the piston member 6 and the (first to third) check valves are activated as in the case of releasing the piston member 4 first time. In this situation, the liquid in the container body 2 is sucked into the liquid chamber B again through the suction tube 15, and the air is sucked into the air chamber A through the suction hole F. As a result, the preparation to produce the form is completed again, and a desired amount of the foam can be discharged from the discharging outlet 43 of the nozzle member 4 by pushing and releasing the nozzle member 4 repeatedly.

In order to introduce external air into the foam dispensing pump container 1 through the air course H between the inner cylinder 41 and the outer cylinder 42, as shown in FIGS. 1 and 2, the suction inlet 45 is formed in the nozzle member 4.

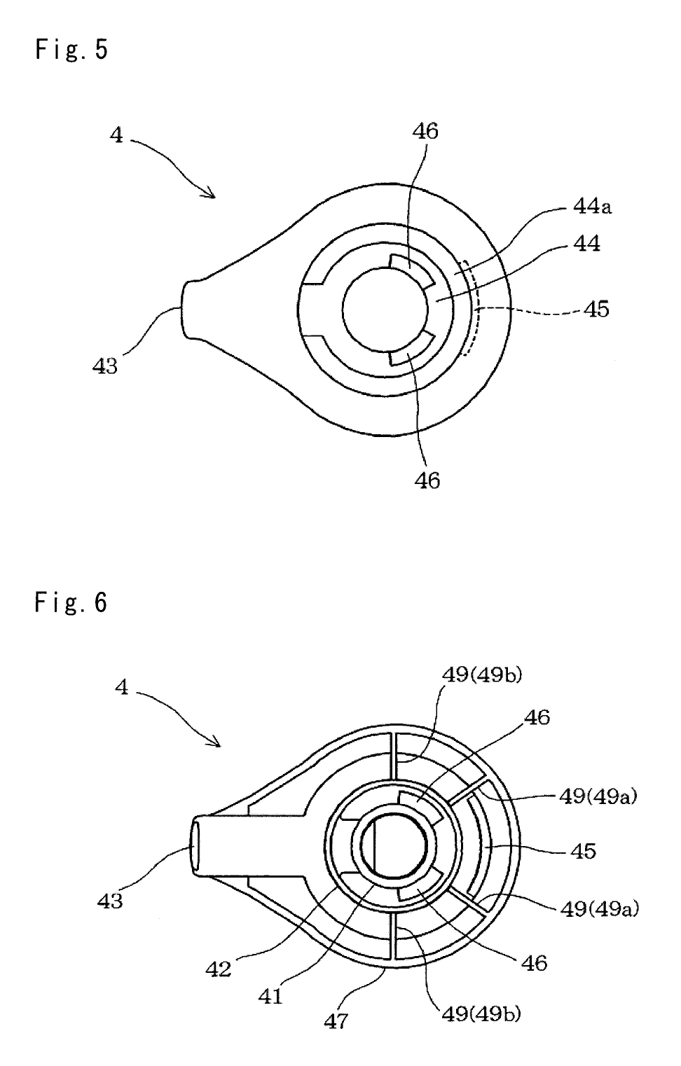

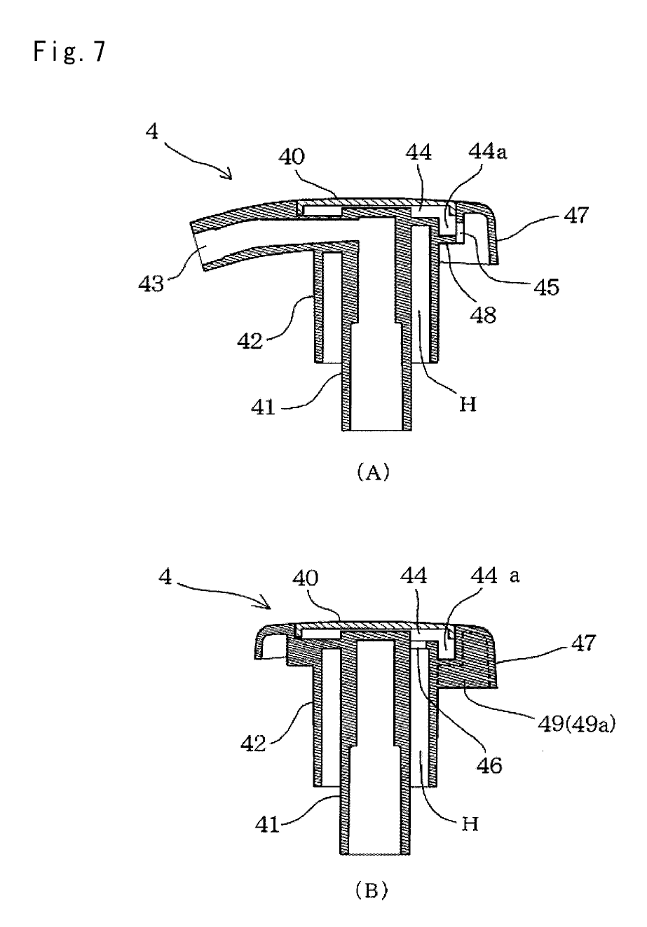

Specifically, as shown in FIGS. 7(A) and 7(B), a space 44 is formed in a ceiling of the nozzle member 4, and the space 44 is closed by a lid 40. The space 44 comprises a recessed portion 44a situated radially outside of the outer circumferential face of the outer cylinder 42. The above-mentioned suction inlet 45 for introducing the external air is formed on an outer wall of the recessed portion 44a. In addition, in order to connect the air course H between the inner cylinder 41 and the outer cylinder 42 with the space 44, a through hole 46 is formed inside of the recessed portion 44a. In the example shown in FIG. 5, the recessed portion 44a is formed by forming a groove around the outer circumferential face of the outer cylinder 42. However, the recessed portion 44a may also be formed by forming the groove outside of a portion of the outer circumferential face of the outer cylinder 42.

In order to prevent the entry of water into the suction inlet 45 from above or from the side, a skirt shaped cover portion 47 is formed to extend downwardly from an outer circumferential edge of a ceiling of the nozzle member 4. Specifically, in order to serve as a waterproof barrier, the cover portion 47 is formed in the outer circumferential side of the outer wall of the recessed portion 44a, and extended downwardly to a level lower than the suction inlet 45.

According to the example shown in the accompanying figures, the suction inlet 45 is formed on a bottom corner portion of the outer wall of the recessed portion 44a. In addition, as shown in FIGS. 6, 7 (A) and 7 (B), the suction inlet 45 is formed at a portion which is not overlapped circumferentially with the through hole 46 connecting the air course H between the inner cylinder 41 and the outer cylinder 42 with the space 44.

Accordingly, a space extending in the circumferential direction of the nozzle member 4 is formed between an inner face of the skirt shaped cover portion 47 and the outer cylinder 42. As shown in FIG. 6, a plurality of partitions 49 are formed in the circumferential space thus formed between the cover portion 47 and the outer cylinder 42. Therefore, the circumferential space is divided into a plurality of spaces by the partitions 49. Specifically, at least one pair of partitions 49 are formed in the circumferential direction of the nozzle member 4 on both sides of the suction inlet 45 formed on the outer wall of the recessed portion 44a.

According to the example shown in the accompanying figures, specifically, a pair of partitions 49a are formed in the vicinity of both circumferential ends of the suction inlet 45, and another pair of partitions 49b are formed on positions predetermined distance away from the circumferential ends of the suction inlet 45. In other words, said another pair of partitions 49b are formed on each intermediate location between the suction inlet 45 and the discharging outlet 43. Thus, in the example, the two pairs of the partition walls 49a and 49b, (i.e., four walls in total) are formed.

As described, the recessed portion 44a is formed around the outer circumferential face of the outer cylinder 42. Therefore, as shown in FIG. 7 (B), each partition 49 is formed within the area enclosed by the inner face of the skirt shaped cover portion 47, a lower face of the ceiling of the nozzle member 4, an outer wall and a bottom wall 48 of the recessed portion 44a, and the outer circumferential face of the outer cylinder 42. Although not especially shown, in case of forming the recessed portion 44a outside of a portion of the outer circumferential face of the outer cylinder 42, the partition wall 49 may be formed within an area enclosed by the inner face of the skirt shaped cover portion 47, the lower face of the ceiling of the nozzle member 4, and the outer circumferential face of the outer cylinder 42.

According to the foam dispensing pump container 1 thus has been explained, the suction inlet 45 of the nozzle member 4 has a comparatively large opening area. Therefore, a large amount of external air can be sucked into the foam dispensing pump container 1 quickly from the suction inlet 45, so that the foam dispensing pump container 1 is allowed to discharge the foam of the content quickly in a large amount. In addition, ingress of water into the foam dispensing pump container 1 from above or from the side can be prevented by the skirt shaped cover portion 47.

For example, in case the foam dispensing pump container 1 falls sideways, or in case the foam dispensing pump container 1 is inclined obliquely downwardly, water adhering to the outer circumferential face of the outer cylinder 42 is flown toward the suction inlet 45. However, the suction inlet 45 is formed on the outer wall of the recessed portion 44a situated outer circumferential side of the outer circumferential face of the outer cylinder 42. Therefore, in those situations, the bottom wall 48 of the recessed portion 44a serves as a waterproof barrier to block the water flowing toward the suction inlet 45. Thus, according to the present invention, the ingress of water into the foam dispensing pump container 1 from the suction inlet 45 can be prevented effectively.

In case of discharging the foam onto a hand (or a sponge on the hand) placed underneath the discharging outlet 43 by pushing the nozzle member 4 several times, the discharged foam is heaped on the hand (or on the sponge). In this situation, if the hand (or the sponge) on which the foam is heaped is contacted with the outer cylinder 42 of the nozzle member 4, a portion of the foam on the hand (or the sponge) may flow into the inner space of the cover portion 47 via the outer circumferential face of the outer cylinder 42. According to the foam dispensing pump container 1 of the present invention, however, the inner space of the skirt shaped cover portion 47 is divided by the partitions 49. Therefore, the foam thus flowing through the inner space of the cover portion 47 in the circumferential direction of the nozzle member 4 toward the suction inlet 45 is blocked by the partitions 49 to be prevented from approaching to the suction inlet 45. As a result, the foam can be prevented effectively from being aspirated into the container (or the air chamber) together with the external air from the suction inlet 45.

The foam flowing toward the suction inlet 45 is thus blocked by the partitions 49 and heaped on the hand (or sponge). Therefore, the user is allowed to wash his/her hair, face, hand or whole body using the foam thus discharged in a sufficient amount after stop pumping.

As described, according to the example, the suction inlet 45 is formed by cutting the bottom corner portion of the outer wall of the recessed portion 44a. Therefore, the suction inlet 45 can be formed easily using upper and lower molds for forming the nozzle member 4. That is, a structure of the mold or a forming device for forming the nozzle member 4 can be simplified.

As also described, according to the example, the suction inlet 45 is not overlapped with the through hole 46 connecting the air course H with the space 44 in the circumferential direction. Therefore, even if water enters into the suction inlet 45, it is difficult for the intruding water to enter into the air course H between the inner cylinder 41 and the outer cylinder 42 directly from the through hole 46. In addition, the water thus enters into the recessed portion 44a is drained from the suction inlet 45 when the foam dispensing pump container 1 is erected upright. For this reason, the ingress of the water into the foam dispensing pump container 1 can be prevented more certainly.

In addition, according to the example, the partitions 49a are formed inside of the cover portion 47 in the vicinity of each circumferential end of the suction inlet 45, and the partitions 49b are additionally formed at portions away from the partitions 49a, that is, at each intermediate portion between the partition 49a and the discharging outlet 43. Therefore, even in case the foam is discharged more than necessary as a result of unnecessary pumping operations repeated by the user unconsciously, and a portion of the foam thus discharged excessively flows oppositely toward the suction inlet 45 beyond the partition 49b, the intruding foam is blocked at the vicinity of the circumferential end of the suction inlet 45 by the partition 49a. For this reason, the ingress of the form into the suction inlet 45 can be prevented more certainly.

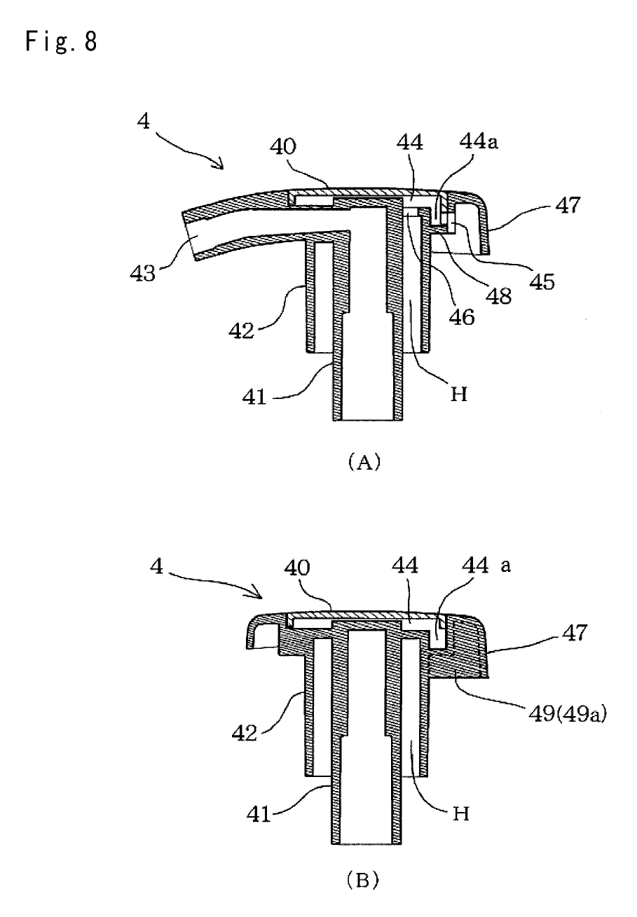

The present invention should not be limited to the example of the foam dispensing pump container 1 thus has been explained. According to the example thus far explained, as shown in FIGS. 7(A) and 7(B), the suction inlet 45 and the through holes 46 are arranged in a manner not to be overlapped with each other in the circumferential direction. Alternatively, as shown in FIGS. 8(A) and 8(B), the suction inlet 45 and the through holes 46 are arranged to be overlapped in the circumferential direction of the nozzle member 4.

In addition, according to the example shown in FIGS. 7(A) and 7(B), a skirt portion around the lid 40 is extended downwardly and evenly to the extent that a lower end thereof does not reach the suction inlet 45. However, in order to fix the lid 40 firmly onto the nozzle member 4, the skirt portion of the lid 40 may also be extended entirely to the vicinity of a lower end of a circumferential wall of the space 44 as shown in FIGS. 8(A) and 8(B). In this case, the skirt portion of the lid 40 is cut at a level of the suction inlet 45.

As shown in FIG. 6, according to the above-explained example, the two pairs of partitions 49a and 49b are arranged. However, one of those pairs of partitions 49a and 49b may be omitted. Alternatively, three or more pairs of partitions may also be formed. In addition, it is preferable to arrange the partition 49 closer to the suction inlet 45 than the discharging outlet 43. However, location of the partition 49 may be changed arbitrarily.

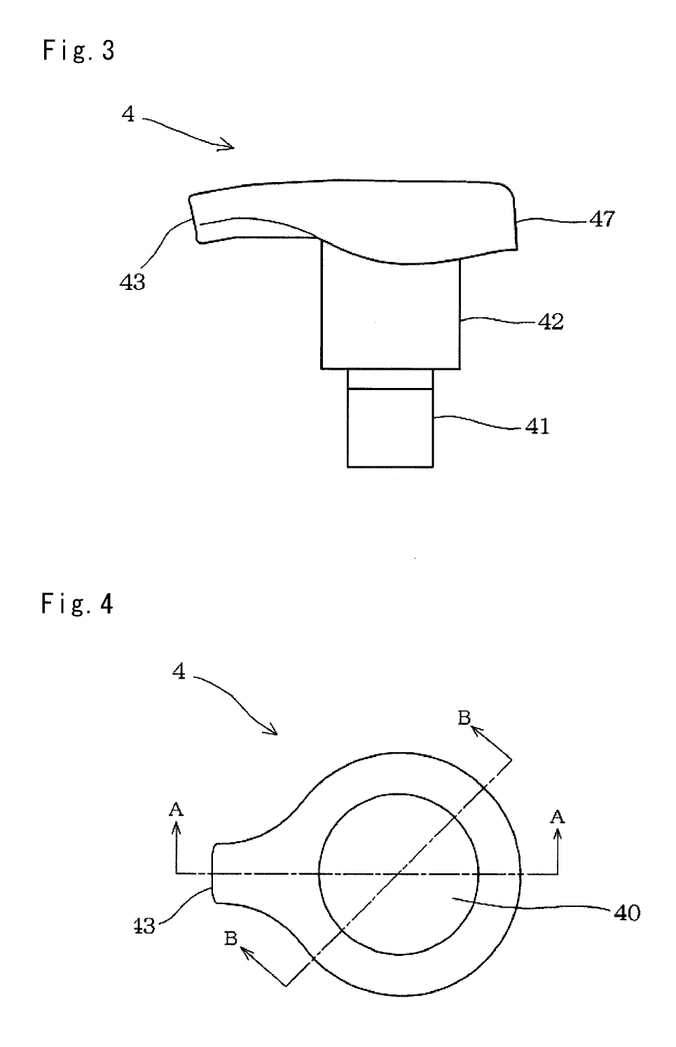

In order to improve the appearance, as shown in FIG. 3, the skirt shaped cover portion 47 is extended downwardly below the suction inlet 45 even within the circumferential area away from the suction inlet 45. However, the skirt shaped cover portion 47 thus structured does not function sufficiently as the waterproof barrier to prevent the ingress of water into the suction inlet 45 in the region far away from the suction inlet 45. Therefore, according to the present invention, the lower end of the skirt shaped cover portion 47 may be situated at a level above the suction inlet 45. For example, in case the pair of partitions 49 is arranged in the vicinity of each end of the suction inlet 45 as shown in FIG. 6, the skirt shaped cover portion 47 may be extended only to the level above the suction inlet 45 within the regions between each partition 49a and the discharging outlet 43. Otherwise, the skirt shaped cover portion 47 may not be arranged in those regions.

Alternatively, in case of eliminating the partitions 49a from both ends of the suction inlet 45 and arranging only the partitions 49b of the discharging outlet 43 side, it is desirable to extend the skirt shaped cover portion 47 to the level lower than the suction inlet 45 within each region from the intermediate portion between the discharging outlet 43 and the suction inlet 45 to the suction inlet 45. However, the cover portion 47 may also be extended only to the level above the suction inlet 45 within each region from the intermediate portion between the discharging outlet 43 and the suction inlet 45 to the discharging outlet 43. Otherwise, the skirt shaped cover portion 47 may not be arranged in those regions. In this case, however, in order to ensure a height of the partitions 49b sufficiently, and in order to prevent a flowage of the foam, it is desirable to extend the cover portion 47 downwardly to the level lower than the suction inlet 45 in the vicinity of the partitions 49b.

In addition, the structure of the pumping mechanism of the foam dispensing pump container, e.g., structures of the first to third check valves are also not limited to the above-explained example. That is, the structure of the pumping mechanism may be replaced arbitrarily by the known structure if it is suitable to arrange the suction inlet 45 and the partitions 49.

1-5. (canceled)

6. A foam dispensing pump container, comprising:
a cylinder member extending from an opening of a container toward an inner space of the container;
a piston member, which is arranged in the cylinder member in a manner to reciprocate vertically within a predetermined range, and which is constantly pushed upwardly;
a cap, which is fitted onto the opening of the container to cover the piston member from above;
a cylindrical guide stem, which is erected around an opening edge of a top panel of the cap;
a nozzle member, which is arranged outside of the container, and which has a discharging outlet, an inner cylinder connected with the piston member to form a discharging passage, and an outer cylinder configured to reciprocate vertically on an outer circumferential face of the guide stem; and
an air course, which is formed between the inner cylinder and the outer cylinder to introduce external air into the container;
a space, which is formed in a ceiling of the nozzle member and closed by a lid;
a recessed portion, which is formed outside of an outer circumferential face of the outer cylinder in said space;
a suction inlet, which is formed on an outer wall of the recessed portion and situated on an opposite side of the discharging outlet of the nozzle member to introduce the external air;
wherein a portion of said space inside of the recessed portion is communicated with the air course formed between the inner cylinder and the outer cylinder;
a skirt shaped cover portion, which is formed in the outer circumferential side of the recessed portion, and which extends downwardly from an outer circumferential edge of the ceiling of the nozzle member to a level lower than the suction inlet; and
a partition, which is arranged on both sides of the suction inlet in a circumferential direction of the nozzle member to divide and close an inner space of the skirt shaped cover portion.

7. The foam dispensing pump container as claimed in claim 6,
wherein the partition includes a pair of partitions arranged at portions predetermined distance away from each end portion of the suction inlet in the circumferential direction of the nozzle member.

8. The foam dispensing pump container as claimed in claim 6,
wherein the partition includes a pair of partitions arranged in the vicinity of each end portion of the suction inlet in the circumferential direction of the nozzle member.

9. The foam dispensing pump container as claimed in claim 6,
wherein the suction inlet is formed by cutting the outer wall of the recessed portion at a bottom corner portion of the recessed portion.

10. The foam dispensing pump container as claimed in claim 6,
wherein the suction inlet is formed at a portion which is not overlapped with a through hole connecting the air course between the inner cylinder and the outer cylinder with said space in the circumferential direction of the nozzle member.

11. The foam dispensing pump container as claimed in claim 7,
wherein the partition includes a pair of partitions arranged in the vicinity of each end portion of the suction inlet in the circumferential direction of the nozzle member.

12. The foam dispensing pump container as claimed in claim 7,
wherein the suction inlet is formed by cutting the outer wall of the recessed portion at a bottom corner portion of the recessed portion.

13. The foam dispensing pump container as claimed in claim 8,
wherein the suction inlet is formed by cutting the outer wall of the recessed portion at a bottom corner portion of the recessed portion.

14. The foam dispensing pump container as claimed in claim 11,
wherein the suction inlet is formed by cutting the outer wall of the recessed portion at a bottom corner portion of the recessed portion.

15. The foam dispensing pump container as claimed in claim 7,
wherein the suction inlet is formed at a portion which is not overlapped with a through hole connecting the air course between the inner cylinder and the outer cylinder with said space in the circumferential direction of the nozzle member.

16. The foam dispensing pump container as claimed in claim 8,
wherein the suction inlet is formed at a portion which is not overlapped with a through hole connecting the air course between the inner cylinder and the outer cylinder with said space in the circumferential direction of the nozzle member.

17. The foam dispensing pump container as claimed in claim 9,
wherein the suction inlet is formed at a portion which is not overlapped with a through hole connecting the air course between the inner cylinder and the outer cylinder with said space in the circumferential direction of the nozzle member.

18. The foam dispensing pump container as claimed in claim 11,
wherein the suction inlet is formed at a portion which is not overlapped with a through hole connecting the air course between the inner cylinder and the outer cylinder with said space in the circumferential direction of the nozzle member.

19. The foam dispensing pump container as claimed in claim 12,
wherein the suction inlet is formed at a portion which is not overlapped with a through hole connecting the air course between the inner cylinder and the outer cylinder with said space in the circumferential direction of the nozzle member.

20. The foam dispensing pump container as claimed in claim 13,
wherein the suction inlet is formed at a portion which is not overlapped with a through hole connecting the air course between the inner cylinder and the outer cylinder with said space in the circumferential direction of the nozzle member.

21. The foam dispensing pump container as claimed in claim 14,
wherein the suction inlet is formed at a portion which is not overlapped with a through hole connecting the air course between the inner cylinder and the outer cylinder with said space in the circumferential direction of the nozzle member.
